(19) United States
(12) Patent Application Publication
(10) Pub. No.: US 2026/0222194 A1
(43) Pub. Date: Jul. 30, 2026

(54) DEPENDENCY-AWARE CREDENTIAL ROTATION FRAMEWORK

(71) Applicant: Hewlett Packard Enterprise Development LP, Spring, TX (US)

(72) Inventors: Reubenur Rahman, Bangalore (IN); Arunkumar Viswanathan, Bangalore (IN); Manjunath Rajendra Batakurki, Bangalore (IN); Ravi Kumar, Bangalore (IN); Mahesh Nakkireddy, Bangalore (IN)

(21) Appl. No.: 19/193,785

(22) Filed: Apr. 29, 2025

(30) Foreign Application Priority Data
Jan. 28, 2025 (IN) 202511006935

(51) Int. Cl. H04L 9/08

(52) U.S. Cl. CPC H04L 9/0891; H04L 9/0861

(57) ABSTRACT

According to an implementation, a credential rotation system provides automated coordination of credential updates across interdependent computing devices. A central manager receives component registrations containing credential configurations and dependency information. The manager maintains a dependency graph tracking which components rely on service accounts from other components, generates new credentials according to defined policies, and orchestrates synchronized updates through component-specific agents. When rotation is triggered for a component's service account, the manager identifies dependent components using the dependency graph and coordinates credential updates to maintain operational continuity. Component-specific agents handle local credential rotation and updates while the manager ensures system-wide coordination through dependency tracking and automated notification.

### BACKGROUND

Modern computing environments rely on service account credentials to secure components' interactions. These credentials, which can include passwords, Application Programming Interface (API) keys, and tokens, allow one component to authenticate and perform operations through another component's services. For example, hypervisor management systems maintain distinct administrative credentials for compute, network, and storage operations in virtualized environments. When a compute management component needs to provision virtual machines, it authenticates using compute administration credentials, while network configuration changes require separate network administration credentials.

Enterprise deployments, particularly in cloud infrastructure, comprise numerous components that form multi-layered authentication dependencies. A storage management component may depend on credentials from virtualization and network components to function properly. Similarly, application deployment services often require credentials from multiple underlying infrastructure components. Organizations regularly rotate these service account credentials as part of security compliance requirements and to limit potential unauthorized access. The frequency and scope of credential rotation typically align with specific security policies and compliance standards such as the General Data Protection Regulation (GDPR), Payment Card Industry Data Security Standard (PCI DSS), and Health Insurance Portability and Accountability Act (HIPAA).

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is a simplified computing environment;

FIG. 2 is a block diagram of a component;

FIG. 3 is a block diagram of a system for credential rotation;

FIG. 4 is a block diagram of a dependency arrangement;

FIG. 5 is a flowchart of an implementation method for component configuration registration and scheduling;

FIG. 6 is a flowchart of an implementation method for credential rotation and dependent component update;

FIG. 7 is a flowchart of an implementation method for credential rotation; and

FIG. 8 is a flowchart of an implementation method for agent credential rotation.

### DESCRIPTION

The following disclosure provides many different examples for implementing different features. Specific examples of components and arrangements are described below to simplify the present disclosure. These are, of course, merely examples and are not intended to be limiting.

The particular implementations are merely illustrative of specific configurations and do not limit the scope of the claimed implementations. Features from different implementations may be combined to form further examples unless noted otherwise. Various implementations are illustrated in the accompanying drawing figures, where identical components and elements are identified by the same reference number, and repetitive descriptions are omitted for brevity.

Variations or modifications described in one of the implementations may also apply to others. Further, various changes, substitutions, and alterations can be made herein without departing from the spirit and scope of this disclosure as defined by the appended claims.

While the implementations are described primarily in the context of cloud- based virtualization environments, the disclosed aspects may also apply to other computing architectures requiring credential management. In particular, aspects of the disclosure may similarly apply to container orchestration platforms, database management systems, enterprise resource planning systems, or any distributed computing environment where components authenticate using service account credentials. The credential rotation framework described herein can coordinate updates across interdependent components regardless of the specific type of credentials or authentication mechanisms used by those components.

Aspects of the disclosure propose a credential rotation architecture that provides automated coordination of credential updates across computing environments. In implementations, a central secret management system includes a processor coupled to a secure storage device and memory. The secure storage device can store encrypted credentials, while the memory can store instructions executed by the processor and credential configurations, rotation policies, and dependency information. The dependency information can be employed to track relationships between computing devices that share credentials, enabling synchronized updates without service disruptions.

In implementations, each remote computing device includes a processor and memory storing credential management instructions. When executed by the processor, these instructions enable the device to register with the secret management system by providing credential configurations and relationship information. For example, a compute management device may register its reliance on virtualization platform credentials for managing virtual machines. The secret management system can use the registrations to maintain current dependency information, which may be implemented as a dependency graph that dynamically updates as relationships form or change.

When rotation is triggered for a device's credentials through, for example, a scheduled policy or administrator request, the secret management system's processor can be configured to generate new credentials according to defined security parameters. The system can store the new credentials in the secure storage device and notify the target device to perform the update. The processor can analyze the dependency information to identify devices that rely on the rotated credentials, ensuring comprehensive update coordination.

The secret management system can orchestrate synchronized updates by notifying each dependent device to update its stored credentials. For example, when a virtualization platform rotates its compute administration credentials, the system automatically notifies dependent compute management devices to update their stored credentials. This automated synchronization eliminates manual tracking and updates, reducing human error while maintaining continuous operational access across the environment.

The framework can be adapted to environment changes through dynamic updates of dependency information. As devices register or modify configurations, the secret management system can update its records to reflect new credential relationships. The system can support various credential types, including passwords, Application Programming Interface (API) keys, and authentication tokens used across different layers of computing infrastructure. Regular automated rotation (e.g., without human intervention) provides comprehensive protection against security breaches. These and additional details are further discussed below.

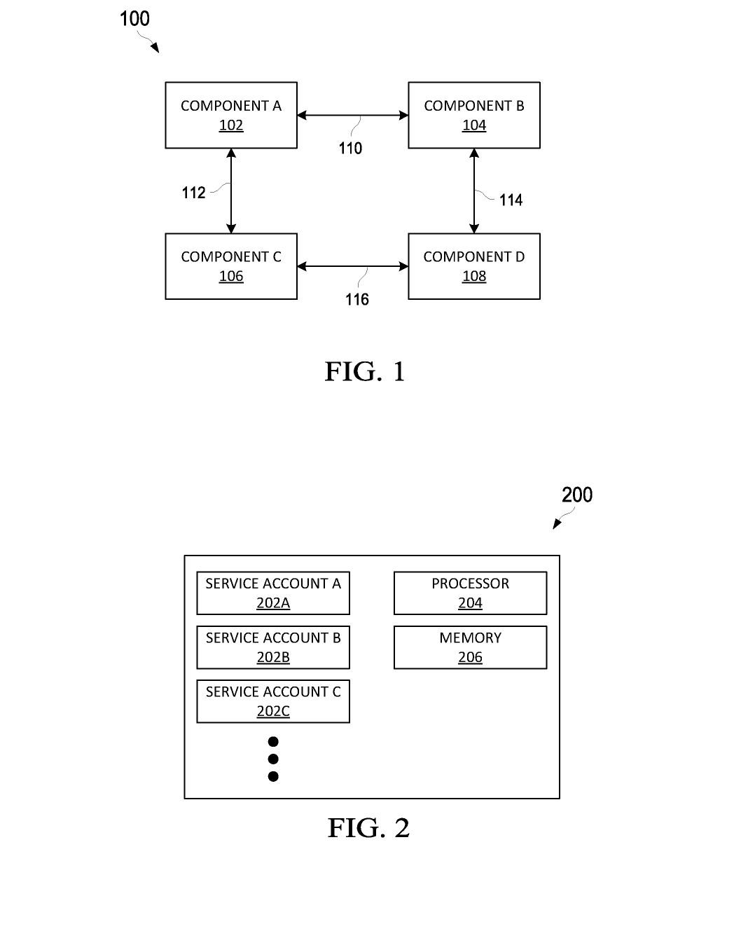

FIG. 1 illustrates a simplified computing environment 100 where multiple software components communicate with each other using credentials for authentication and authorization. The computing environment 100 includes a component A 102, a component B 104, a component C 106, a component D 108, a first communication path 110, a second communication path 112, a third communication path 114, and a fourth communication path 116, which may (or may not) be arranged as shown. The computing environment 100 may include additional components or communication paths not shown, such as a communication path from component B 104 to component C 106.

A component can represent a distinct software system that provides specific functionality within a computing environment. Components can range from infrastructure management systems to application services. For example, a component may be a virtualization platform managing compute resources, a storage system providing data services, or a network controller handling network configurations.

Each component typically includes processing capabilities, memory for storing operational data, and interfaces for communicating with other components. Components expose their functionality through interfaces other components can access after proper authentication. For example, a storage component may expose interfaces for data access, volume management, and configuration operations

Components can operate at different levels of the system architecture. Infrastructure-level components may manage hardware resources, while higher-level components may provide application services. For example, a hypervisor component can manage virtual machines and hardware resources, while a database component provides data storage and retrieval services to applications.

Generally, the functionality of a component determines its interaction patterns with other components, as illustrated in the example of FIG. 1. A resource management component may need to communicate with multiple infrastructure components to coordinate resource allocation. Similarly, an application service component may depend on database components for data storage and network components for connectivity.

Each communication path represents credential-based interactions between components, where components use passwords, Application Programming Interface (API) keys, tokens, or the like to authenticate. Component A 102 and component B 104 communicate via the first communication path 110, component A 102 interacts with component C 106 via the second communication path 112, component B 104 communicates with component D 108 via the third communication path 114, and component C 106 exchanges information with component D 108 via the fourth communication path 116.

In environments requiring compliance with regulations such as the General Data Protection Regulation (GDPR), Payment Card Industry Data Security Standard (PCI DSS), or Health Insurance Portability and Accountability Act (HIPAA), these credentials need regular rotation to reduce unauthorized access risks. The communication paths may utilize different types of credentials depending on the specific interaction requirements between components. For example, the first communication path 110 may use API keys for programmatic access, while the second communication path 112 may use password-based authentication for administrative functions. Each credential type may have different rotation requirements and security parameters.

Components may also maintain multiple credentials for different privilege levels or functions along the same communication path. For example, component A 102 may use one set of credentials for read operations and another for write operations when communicating with component B 104 via the first communication path 110. This multiplies the number of credentials requiring coordinated rotation.

When credentials along any path change, both components need synchronized updates to maintain operational continuity. For example, if component A 102 rotates credentials for the first communication path 110, component B 104 needs corresponding updates to maintain access. Credential changes can disrupt communication between components without proper coordination, leading to system downtime or security vulnerabilities.

Manual tracking and updating of credentials across multiple components can introduce several risks. System administrators need to identify dependent components affected by a credential rotation, coordinate the timing of updates, and verify successful implementation across all communication paths. This process can become increasingly error-prone as the number of components and dependencies grows.

The timing of credential updates can also present operational challenges. If component B 104 receives updated credentials before component A 102 implements the rotation, or vice versa, the first communication path 110 breaks until both components synchronize. This timing dependency exists for each communication path in the environment, creating multiple potential points of failure during credential rotation.

Security vulnerabilities may arise during the credential rotation process itself. During the transition period when credentials are being updated across components, there may be moments when both old and new credentials are valid, potentially creating security exposure. Without proper coordination, this transition window could extend longer than necessary, increasing security risks.

Many of these components may need to maintain continuous real-time operations. For example, if component A 102 provides critical services to component B 104, even brief disruptions during credential rotation could impact business operations. This necessitates careful orchestration of credential updates to maintain both security and operational continuity across all communication paths.

Components may have cascading dependencies that complicate the rotation process. For example, component D 108 depends on credentials from component B 104 and component C 106. If these credential rotations occur near the same time without coordination, component D 108 may experience multiple disruptions or conflicting updates that affect system stability.

The challenge extends beyond maintaining current operations. As computing environments grow, new components may be added with additional dependencies on existing credentials. Each new component and communication path increases the complexity of coordinating credential rotations while maintaining secure system operation.

The computing environment 100 represents a simplified example for illustration. In practice, enterprise environments may include dozens or hundreds of components with intricate webs of credential dependencies. The complexity of managing credential rotations grows exponentially with each additional component and communication path, highlighting the need for systematic credential rotation management.

FIG. 2 illustrates a block diagram of a component 200 that maintains multiple service accounts for system-to-system interactions in an implementation. Component 200 may include a processor 204 and non-transitory memory 206 for storing instructions that, when executed by the processor, implement the component's operational functions. Further, component 200 includes a first service account A 202A, a second service account B 202B, a third service account C 202C, and may include additional service accounts. The number of service accounts is non-limiting and fewer or greater number of service accounts are contemplated in other implementations. The number and types of service accounts can vary based on the component's functions and security requirements.

Each service account acts as a gatekeeper for specific functions or resources within component 200. For example, when another component is to perform operations on component 200, it authenticates using credentials from the appropriate service account. The service account then grants access to those functions and resources associated with its defined privileges. This granular access control enables component 200 to expose different capabilities to different components while maintaining security boundaries between functions.

Service accounts differ from user accounts in that they are typically designed for automated interactions between software components rather than human access. Generally, the credentials for these service accounts adhere to organizational security policies and require regular rotation while maintaining the continuous operation of dependent components.

For example, service account A 202A may be configured as a compute administration account that allows other components to manage computational resources. The second service account B 202B may function as a network administration account for network configuration operations, while the third service account C 202C may serve as a storage administration account for managing storage resources.

When a service account credential requires rotation, any component using that service account needs synchronized updates to maintain access. For example, if the credential of the service account A 202A is rotated, the component managing computational resources that authenticate using these credentials are to be updated with the new credentials. Similarly, when the network administrator's credential for the service account B 202 is rotated, the network management component requires corresponding updates to maintain its ability to perform network configuration operations. This synchronization ensures uninterrupted access to component 200's functions while maintaining security through regular credential rotation.

The timing and coordination of these updates are central to prevent service disruptions. For example, when the credential for the storage administrator of the third service account C 202C is rotated, component 200 ensures the storage management component receives and implements the new credentials before the old credentials become invalid. This coordination prevents scenarios where dependent components lose access to storage management functions during the credential transition period.

Multiple service accounts may require rotation within similar timeframes, adding complexity to the synchronization process. For example, if the second service account B 202B and the third service account C 202C require rotation, component 200 coordinates updates with network and storage management components while maintaining their respective access capabilities. Each dependent component may have different update procedures and verification requirements that are to be satisfied during the rotation process.

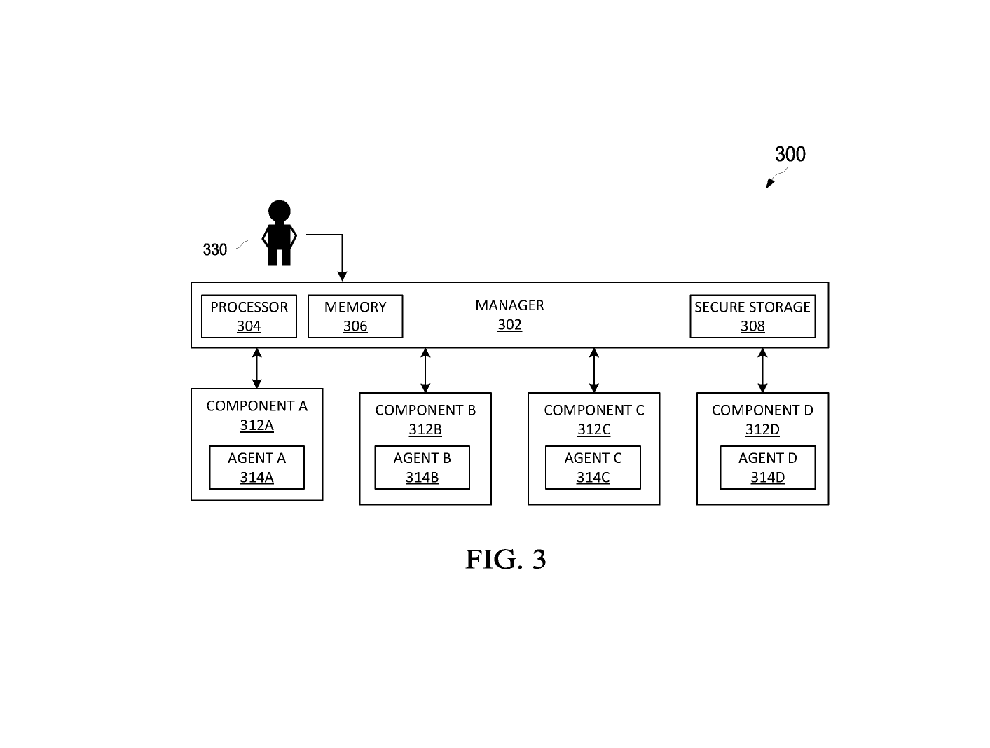

FIG. 3 illustrates a block diagram of a system 300 for credential rotation. System 300 includes a manager 302, a component A 312A, a component B 312B, a component C 312C, and a fourth component D 312D, which may (or may not) be arranged as shown. The system 300 may include additional components beyond those illustrated in FIG. 3. For example, system 300 may include additional components.

System 300 provides centralized management of credential rotation operations while maintaining operational continuity across components. The system manages dependencies between components during and after credential rotation operations by tracking which components rely on credentials from other components, determining update sequences, and ensuring proper notification and verification of credential changes.

To prevent operational disruptions, system 300 can include mechanisms to verify successful credential propagation at each step of the rotation process. If failures occur during rotation, changes can automatically be rolled back to maintain system stability.

In implementations, manager 302 includes a processor 304 coupled to a memory 306 and a secure storage 308. Memory 306 may be non-transitory memory, such as random-access memory (RAM), read-only memory (ROM), flash memory, or other suitable storage media. Memory 306 stores instructions that, when executed by processor 304, enable manager 302 to coordinate credential rotation. The secure storage 308 stores encrypted credentials and maintains credential versions for debugging rotation failures.

Manager 302 exposes interfaces through which components 312 register and interact with system 300. Each component 312 registers itself through its respective agent 314 by providing configuration information and credential policies. In implementations, when manager 302 receives a registration request, it validates the incoming information against predefined schemas to ensure consistency and completeness before storing it in, for example, memory 306. This registration process enables tracking of component relationships and credential requirements.

Dependency information may be implemented in various ways, such as through a dependency graph where components depending on credentials from other components are recorded and tracked. Manager 302 can use this dependency information to coordinate updates during rotation operations.

Manager 302 defines and maintains policies governing credential generation and rotation. These can include a global default policy and specific operational policies controlling, for example, rotation frequency and tenant-specific requirements. Components 312 may specify their own credential policies during registration, but the global default policy can be applied when component-specific policies are not defined. The policies can accommodate various security standards, such as Security Technical Implementation Guide (STIG) compliance requirements.

In implementations, during operation, manager 302 maintains configurable schedules for credential rotation. When a scheduled rotation time arrives, manager 302 identifies components needing rotation, generates new credentials according to applicable policies, and stores them in secure storage 308. Manager 302 then notifies the target component's agent to perform the rotation and, after confirmation, coordinates updates with dependent components' agents 314.

While rotation can typically occur on schedule, administrator 330 may trigger immediate rotation operations through manager 302 for a single component, component group, or all components. This capability supports security incident remediation when desired.

Components 312 correspond functionally to the components described in FIGS. 1 and 2, maintaining similar (or different) communication paths and service account structures. However, in system 300, each component includes a respective agent 314 that handles credential management operations for that component 312. These agents 314 serve as intermediaries between their associated components and manager 302, managing local credential operations while coordinating with the centralized management system.

Each agent 314 can be a software component specifically developed for its respective component 312, understanding its unique architecture and operational requirements. Agent 314 acts as a wrapper for its component 312, handling all credential-related interactions with manager 302 while masking the complexity of the component's internal implementation.

Each agent is responsible for registration and rotation operations with manager 302. During registration, the agent provides manager 302 with detailed configuration information about its component's service accounts and credential requirements.

For example, if component A 312A maintains multiple service accounts, as shown in the example of FIG. 2, agent A 314A provides manager 302 with the configuration details and rotation policies for each account. This registration can include credential types, rotation requirements, access parameters, and any component-specific security policies that should govern credential management.

Agents 314 handle outbound and inbound credential operations. For outbound operations, when component 312 needs to rotate its own service account credentials, its agent 314 can coordinate with manager 302 to execute the rotation according to defined policies. For inbound operations, when a component 312 depends on credentials from another component 312, its agent 314 receives notifications from manager 302 about credential updates and implements the changes to maintain access.

For example, agent A 314A manages credential operations for component A 312A. When the service account credentials of component A 312A need rotation, agent A 314A receives instructions from manager 302 and executes the rotation process. Similarly, if component A 312A depends on credentials from component B 312B, agent A 314A receives notifications from manager 302 when those credentials change and updates the stored credentials accordingly.

During registration, agents 314 provide manager 302 with their component's configuration information, including details about service accounts and credential policies. In implementations, agents 314 maintain local credential update routines specific to their component's requirements while adhering to the overall coordination managed by manager 302. This architecture enables standardized credential management across diverse components while accommodating component-specific implementation details.

In some implementations, agent 314 maintains two sets of routines for credential management. The first set handles the rotation of the service account credentials of its associated component 312. In response to receiving a callback from manager 302 to perform credential rotation, agent 314 can execute these routines to update its component's service accounts. The second set of routines manages updates to credentials that its associated component 312 uses to access other components. When manager 302 notifies agent 314 about credential changes in dependent components, these routines update the stored credentials to maintain access.

For example, when agent A 314A receives a callback from manager 302 to rotate the service account credentials for component A 312A, agent A 314A executes its rotation routines to implement the change. Similarly, when component A 312A depends on credentials from another component, agent A 314A receives a callback from manager 302 about the credential change and executes its update routines to maintain the dependency.

To illustrate component configuration, consider component A 312A to be a central server coupled to component B 312B, which is a dependent component (e.g., a compute manager, a network manager, a storage manager, etc.). In this configuration, the central server includes distinct service accounts that component B 312B (and potentially other components) used to interact with its services. For example, a first service account can enable authorized components to manage virtual machines, hosts, and compute resources. A second service account can provide access to virtual networking configurations, including virtual switches and network policies. The third service account can allow the management of storage resources, including data stores and storage policies.

In this example configuration, the central server operates as a core infrastructure component that component B 312B depends on, but it does not depend on credentials from other components, such as component B 312B. The configuration for the central server can include rotation policies specific to each service account of the central server, defining parameters such as rotation frequency and security requirements. This configuration information is provided to manager 302 by the agent 314A during the registration process.

Unlike the central server, the dependent components maintain their own service account and depend on service accounts from other components to function. The configuration for the dependent component declares dependencies on service accounts from the central server, indicating that the dependent component requires access to the capabilities of the central server to perform its functions.

Accordingly, in the example above, the dependency relationship between component A 312A and component B 312B is registered by agent B 314B of component B 312B with manager 302 to ensure proper credential rotation coordination. In response to the rotation of credentials of service accounts of the central server to which component B 312B depends, manager 302 communicates the updated credentials through agent B 314B such that component B 312B updates its credentials to maintain operational access with component A 312A.

The agents can participate in the verification and rollback processes. For example, when credential changes occur, agents 314 can verify successful implementation and report the status back to manager 302. If issues arise during rotation, agents 314 can execute rollback procedures as directed by manager 302 to maintain system stability.

It should be appreciated that as each component owner possesses a detailed understanding of their component's internal architecture and operational requirements, while the credential rotation framework defines the configuration structure and protocols that agents follow, the responsibility for developing an agent that correctly implements these requirements falls to the component owner. The agent adheres to the framework's configuration contract while incorporating the specific knowledge to manage credentials for its particular component.

Secure storage 308 provides encrypted storage for credentials used across system 300. The credentials are stored in encrypted form to prevent unauthorized access, with access controls limiting retrieval to manager 302 and administrator 330. This centralized, secure storage approach can ensure credentials are protected at rest and during rotation operations.

Beyond storing current credentials, secure storage 308 can maintain versions of previous credentials for each service account. This version history can serve multiple purposes in maintaining system stability. For example, during the debugging of rotation failures, administrators can access credential versions to identify when and how failures occurred. The version history can also support rollback operations when rotation complications arise, enabling system 300 to restore previous credential states to maintain operational continuity.

Secure storage 308 may implement various security mechanisms to protect stored credentials. These may include but are not limited to, encryption at rest, access logging, and secure communication channels for credential retrieval. When manager 302 generates new credentials during rotation operations, the security mechanisms can ensure they remain protected throughout their lifecycle, from generation through distribution to retirement.

Secure storage 308 provides encrypted storage capabilities to protect credentials across system 300. At its most basic level, secure storage implements encryption at rest for all stored credentials, with access controls limiting retrieval to only manager 302 and administrator 330. This centralized approach ensures credentials remain protected throughout their lifecycle, from initial storage through rotation operations.

The minimum security requirements for secure storage can include encryption of credentials at rest, strict access logging of all credential retrievals and modifications, and secure communication channels for credential transmission. Enhanced security measures can incorporate hardware security modules (HSMs), multi-factor authentication for administrative access, and advanced encryption standards such as AES-256. Additional security layers may include network segmentation to isolate the storage system, regular security audits, and comprehensive backup procedures with encrypted backups.

Examples of secure storage implementations can include dedicated hardware security appliances, encrypted database systems with role-based access controls, or cloud-based key management services with hardware security module integration. For example, a hardware security module can provide tamper-resistant storage with cryptographic operations performed within the secure boundary of the device. Enterprise key management systems offer another example, providing centralized control over encryption keys while maintaining detailed audit logs of all credential access. Cloud providers may offer managed services like AWS Key Management Service or Azure Key Vault that combine secure storage with built-in high availability and disaster recovery capabilities.

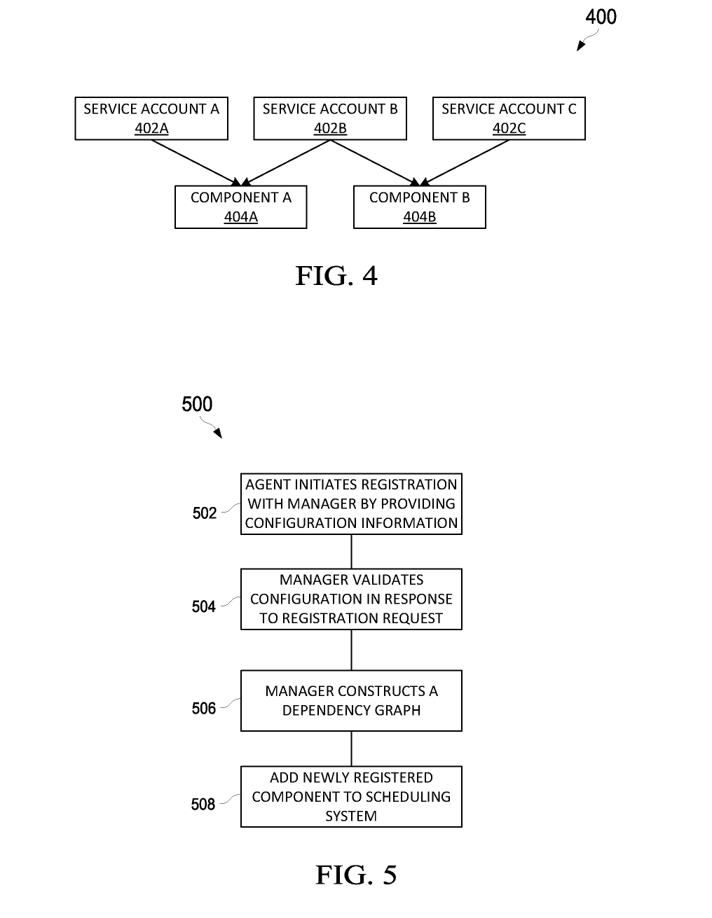

FIG. 4 illustrates a block diagram of a dependency arrangement 400 showing relationships between service accounts and components. The dependency arrangement 400 represents a dependency graph. While dependencies between components and service accounts may be tracked in various ways, this figure demonstrates one implementation using a graph structure.

In this implementation, the service account A 402A, the service account B 402B, and the service account C 402C are represented as top-level nodes or vertices in the graph structure. Each service account represents distinct access credentials maintained by a central component. Component A 404A and component B 404B are components that depend on these service accounts to perform their operations, which are represented as next-level nodes or vertices. The edges (connecting lines) between these vertices indicate which component requires access to specific service accounts.

The arrangement shows that component A 404A requires access to service account A 402A and service account B 402B to function. Similarly, component B 404B depends on service account B 402B and service account C 402C. This illustrates how a single service account, such as service account B 402B, may be used by multiple components, while components may depend on multiple service accounts.

Manager 302 can use this type of dependency arrangement to track relationships between service accounts and components. When credential rotation occurs for any service account, the arrangement enables quick identification of affected components. For example, if service account B 402B requires rotation, the arrangement shows that component A 404A and component B 404B need credential updates.

This graph structure represents one approach to dependency tracking. Other implementations may use different data structures or arrangements, such as dependency matrices or linked lists, to maintain this relationship information. It is advantageous for these implementations to maintain accurate records of which components depend on which service accounts to enable proper coordination during credential rotation operations.

Further, FIG. 4 presents a simplified example of a dependency graph for illustration purposes. In practice, dependency arrangements may include different numbers of service accounts and components than shown and may be structured differently based on system requirements. Accordingly, the number of components, service accounts, and interconnections can vary based on the specific computing environment being managed.

FIG. 5 illustrates a flowchart of an implementation method 500 for component configuration registration and scheduling. It is noted that all steps outlined in the method are not necessarily required and can be optional. Further, changes to the arrangement of the steps, removal of one or more steps and path connections, and addition of steps and path connections are similarly contemplated.

At step 502, the agent of each component within a computing environment initiates registration with the manager by providing its configuration information. This configuration can include details about the component's service accounts, credential policies, and any dependencies on service accounts from other components.

The configuration specifies service accounts maintained by the registering component. Each service account entry can include details such as the account's purpose, access levels, credential requirements, and rotation parameters. For example, a component may maintain separate service accounts for administrative operations, read-only access, and specific functional capabilities, each with different security requirements.

For each service account, the configuration may include specific credential policies that define rotation requirements, password complexity rules, and security parameters. These policies can override global default policies when stricter security measures are desired for particular service accounts. If component-specific policies are not provided, the manager's default policies will govern credential management for that component.

The configuration can also declare dependencies on service accounts from other components for operation. These dependency declarations can specify which service accounts the component needs access to, what types of operations require this access, and any specific requirements for credential updates. For example, a compute management component might register with configuration details for its own service account while also declaring dependencies on compute- admin and network-admin service accounts from a virtualization platform component.

The agent, having specific knowledge of its component's architecture and operational requirements, ensures all configuration details are properly formatted and included in the registration request. The configuration information enables the manager to maintain accurate records of service account relationships and ensure proper coordination during credential rotation operations.

At step 504, the manager processes the registration request by validating the provided configuration. In some implementations, this validation may be performed by a separate configuration management application that checks the configuration against predefined schemas to ensure completeness and consistency. The validated configuration is then stored and managed for future operations.

During validation, the configuration can be checked against predefined schemas that specify mandatory and optional configuration elements. These schemas can define the expected format and content for service account definitions, credential policies, and dependency declarations. The validation process can ensure that mandatory fields are present, data formats are correct, and the configuration adheres to system requirements.

For service account configurations, validation can include checking that each account specification includes parameters such as account type, access levels, and rotation requirements. When component-specific credential policies are included, these can be validated to ensure they meet minimum security requirements while remaining within acceptable operational parameters.

Dependency declarations can be scrutinized during validation to ensure they reference valid service accounts in other components. The validation can verify that declared dependencies align with the system's security model and that the requested access levels are appropriate for the component's intended functions.

Once validation is successful, the configuration can be preserved in a format that enables efficient retrieval and updates during system operation. This stored configuration becomes the authoritative record of the component's service account specifications and dependencies, used by the manager to coordinate credential rotation operations.

At step 506, the manager analyzes the validated configuration to construct a dependency graph for the component. This graph captures the component's relationships with service accounts, both those it maintains and those it depends on. In some implementations, a separate dependency management application may handle the construction and maintenance of these dependency relationships.

The dependency graph can represent service accounts as top-level vertices and components as next-level vertices, with edges indicating relationships between them. For each newly registered component, the manager examines its configuration to identify the service accounts it provides and those it requires from other components. These relationships are integrated into the existing dependency structure.

When building the dependency graph, the manager can maintain an acyclic structure to prevent circular dependencies that could complicate credential rotation. For example, if component A depends on credentials from component B, and component B depends on credentials from component C, the graph can represent these associations as directional relationships that can be traversed to determine the proper sequence for credential updates.

The dependency graph can be dynamically updated as new components register or existing components modify their configurations. This ensures the manager maintains current information about all credential dependencies across the system. The graph structure can enable efficient queries to identify all components affected by the credential rotation of any particular service account.

For example, when the manager needs to rotate credentials for a specific service account, it can traverse the dependency graph to identify all components that depend on those credentials directly or through intermediate dependencies. This information can be advantageous for coordinating synchronized updates and maintaining system stability during credential rotation operations.

At step 508, the manager adds the newly registered component to its scheduling system. This ensures the component will be included in future credential rotation operations according to defined policies and schedules. The scheduler tracks rotation requirements for all registered components and their service accounts.

The manager can maintain configurable schedules for executing credential rotation operations across registered components. These schedules can consider global policies and component-specific requirements defined during registration. For example, some service accounts may require more frequent rotation based on security policies or compliance requirements.

When adding a component to the scheduler, the manager can consider factors such as the rotation frequency specified in the component's credential policies, any default policies that apply when component-specific policies are not defined, and dependencies that might affect rotation timing. The scheduler ensures that credential rotations are coordinated across dependent components to maintain system stability.

In implementations, the scheduling system can accommodate different types of rotation triggers. While most rotations may occur on predetermined schedules, the system can be configured to handle on-demand rotation requests from security administrators, for security incident remediation.

Once a component is added to the scheduler, its service accounts become part of the manager's regular rotation operations. During each scheduled run, the manager evaluates which components need credential rotation by comparing their last rotation time against the defined policies. This ensures that service accounts undergo regular rotation while maintaining operational continuity across the system.

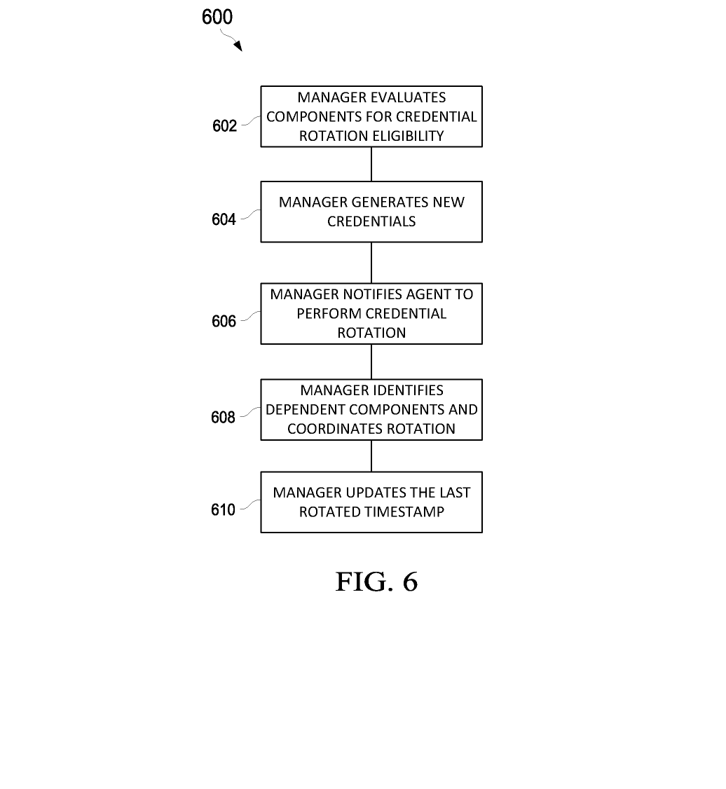

FIG. 6 illustrates a flowchart of an implementation method 600 for credential rotation and dependent component update. It is noted that all steps outlined in the method are not necessarily required and can be optional. Further, changes to the arrangement of the steps, removal of one or more steps and path connections, and addition of steps and path connections are similarly contemplated.

At step 602, the manager evaluates components for credential rotation eligibility during each scheduled interval. For example, the manager compares each component's last rotation timestamp against rotation policies defined in its configuration. Components with credentials exceeding their defined rotation interval are identified for immediate rotation. These policies may come from component- specific configurations or default system policies when component-specific policies are not defined.

Configurable schedules can be maintained by, for example, the manager for executing credential rotation operations across all registered components. During each scheduled run, the manager can retrieve configurations for all registered components from its storage or the configuration management system. These configurations contain critical information about rotation requirements, including frequency, timing constraints, and security parameters.

For each component, the manager can examine component-specific and global policies. Component-specific policies may define unique rotation requirements based on the component's security needs or operational characteristics. For example, components handling sensitive operations may require more frequent credential rotation than those performing routine tasks. When a component does not specify its own policies, the manager can apply default global policies to ensure consistent security practices.

The evaluation process can consider factors beyond just time intervals. The manager can check compliance requirements, such as Security Technical Implementation Guide (STIG) specifications, that may influence rotation timing. It can also consider operational parameters that might affect when rotation can safely occur, such as maintenance windows or system load conditions.

Components identified as requiring rotation can be added to a rotation queue and prioritized based on factors such as time since the last rotation, security requirements, and operational dependencies. This queue can ensure the orderly processing of rotation operations while maintaining system stability.

At step 604, the manager generates new credentials for each component identified as requiring rotation according to the defined policies for that component's service accounts. These policies specify requirements such as credential complexity, format, and security parameters. The newly generated credentials can be stored in secure storage, which maintains them in encrypted form and can preserve previous versions for potential rollback operations.

The credential generation process can follow specific security policies defined for each service account. These policies may include requirements for password length, character composition, encryption standards, and other security parameters. For example, a service account used for administrative functions may require stronger credentials than one used for read-only operations. The manager can apply default global policies to meet minimum security standards when component-specific policies are not defined.

Before generating new credentials, the manager retrieves the component's configuration to understand special requirements or constraints for its service accounts. This can include checking whether the component requires specific credential formats or has limitations on certain character types. The manager can also consider any compliance requirements affecting credential generation, such as specific security standards or regulatory requirements.

Once generated, the new credentials can be stored in the secure storage system. The storage system encrypts the credentials to protect them at rest and maintains strict access controls to prevent unauthorized retrieval. Each set of credentials can be stored with metadata, including its generation timestamp, associated component information, and policy requirements applied during generation.

In some implementations, the secure storage system maintains versions of previous credentials for each service account. This version history can enable rollback operations if problems occur during rotation, support debugging of rotation failures, and provide audit trails for security compliance. The number of previous versions maintained may be configured based on system requirements and storage constraints.

At step 606, the manager notifies the component's agent to perform credential rotation using the newly generated credentials. The manager can provide the agent information to access the new credentials and implement the rotation. The agent, having specific knowledge of its component's implementation, can execute the rotation while maintaining the component's operational state.

The notification process can involve a callback from the manager to the component's agent, providing details about which service account requires rotation and how to access the new credentials from secure storage. Generally, the agent, developed specifically for its component, contains the routines to perform credential rotation while understanding its unique architecture and operational requirements.

Upon receiving the callback, the agent executes its predefined rotation routines. These routines handle the complexities of updating credentials within the component's specific environment. For example, if credentials are rotated for a service account that manages computing resources, the agent ensures the rotation occurs without disrupting ongoing computing operations or active resource management tasks.

In implementations, the agent communicates with the manager throughout the rotation process, providing status updates and confirmation of successful implementation. If any issues arise during rotation, the agent can signal the manager to initiate rollback procedures or take other corrective actions to maintain system stability.

After completing the rotation, the agent can verify that the new credentials are properly implemented and functional. This may include testing authentication with the new credentials and verifying that component operations remain accessible. The agent can confirm the completion of the rotation process to the manager after successful verification.

At step 608, the manager queries the dependency graph to identify components that depend on the rotated credentials. Using this dependency information, the manager can coordinate with the agents of affected components to update their stored credentials. This synchronization ensures that dependent components maintain uninterrupted access to services protected by the rotated credentials.

In implementations, the manager traverses the dependency graph from the service account whose credentials were rotated. For example, if a component's compute-admin service account credentials are rotated, the manager identifies all components in the graph that depend on those specific credentials. This may include multiple components that use the compute-admin credentials for different operational purposes.

After identifying affected components, the manager initiates a coordinated update process through their agents. Each agent receives a callback with information about the credential change and access details for retrieving the new credentials from secure storage. The agents can execute predefined routines to update dependent credentials while maintaining their components' operational states.

The update process can follow a sequence to maintain system stability. Components can be updated in an order that preserves operational dependencies and prevents authentication failures. For example, if multiple components depend on the rotated credentials, the manager can ensure updates occur in a sequence that maintains continuous operation across the system.

In some implementations, the manager monitors the status of each dependent component's update throughout this process. Agents can be configured to provide confirmation when they successfully implement the new credentials, allowing the manager to track progress and identify any issues that arise. If any component encounters problems during the update, the manager can initiate appropriate error-handling procedures while continuing updates for other dependent components.

The synchronization process can include verification steps to ensure all dependent components can authenticate using the new credentials. This verification can help prevent scenarios where partial or incomplete updates could lead to system disruptions. After all dependent components confirm successful credential updates, the manager considers the rotation process complete.

At step 610, after successful rotation and dependent component updates, the manager updates the "last-rotated" timestamp in the component's configuration. This updated configuration can be stored in the manager or configuration management system to maintain accurate rotation tracking and ensure proper scheduling of future rotation operations.

The configuration update can include more than just the timestamp. The manager can record details about the rotation operation, including which service accounts were updated, which dependent components received updates, and any specific parameters or policies applied during the rotation. The comprehensive record can help maintain an audit trail of credential changes and support future troubleshooting if desired.

In implementations with a separate configuration management system, the manager can ensure the updated configuration information is properly synchronized.

The configuration management system can validate the updates against its schemas before storing them, maintaining consistency in the configuration data across the system.

The updated configuration information becomes part of the component's historical record, which the manager can use for various purposes. During future scheduled runs, the manager references these timestamps and rotation records to determine when the next rotations should occur. The historical data also helps identify patterns in credential rotation operations that might inform policy adjustments or system optimizations.

The manager uses the updated records during its next scheduled evaluation to ensure all components maintain compliance with their defined rotation policies while preserving operational continuity across the system.

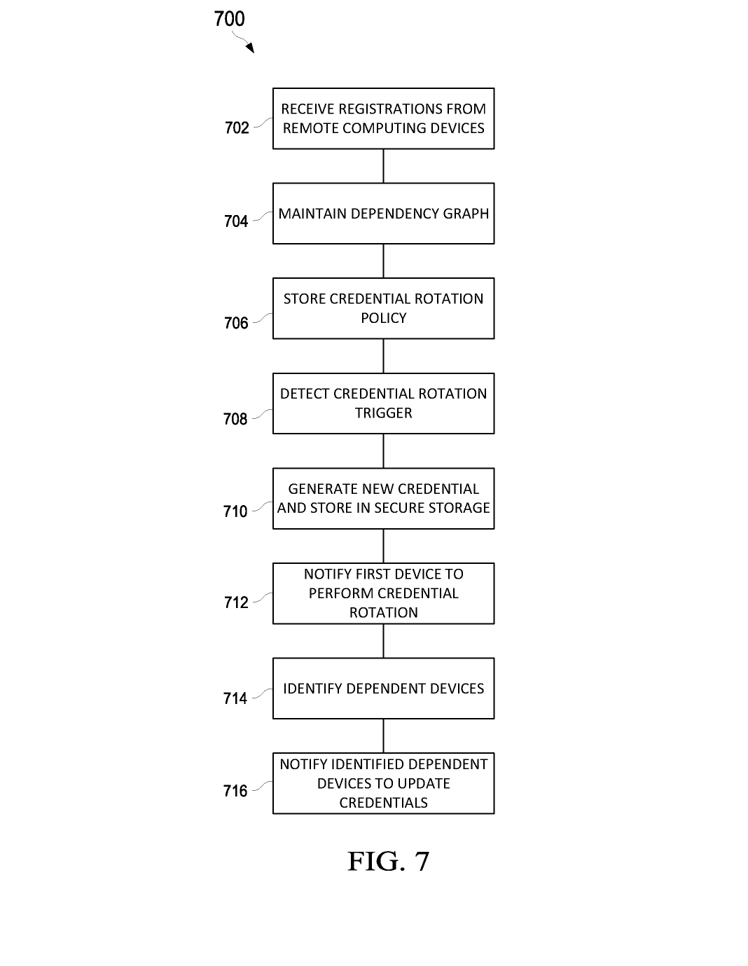

FIG. 7 illustrates a flowchart of an implementation method 700 for credential rotation. It is noted that all steps outlined in the method are not necessarily required and can be optional. Further, changes to the arrangement of the steps, removal of one or more steps and path connections, and addition of steps and path connections are similarly contemplated.

At step 702, a processor receives registrations from remote computing devices. Each registration includes credential configurations specifying service accounts and dependency information indicating which service accounts from other devices are mandatory for operation.

At step 704, the processor maintains a dependency graph in non-transitory memory storage based on the received registrations. The graph tracks relationships between service accounts and the remote computing devices that depend on them.

At step 706, the processor stores credential rotation policies in the non- transitory memory storage. These policies define requirements for credential generation and rotation schedules.

At step 708, the processor detects a credential rotation trigger for a first remote computing device. This trigger may be based on a scheduled rotation time or administrator request.

At step 710, the processor generates new credentials and stores them in a secure storage device according to the stored policies.

At step 712, the processor notifies the first remote computing device to perform credential rotation using the new credentials stored in the secure storage device.

At step 714, the processor identifies dependent remote computing devices by analyzing the dependency graph to determine which devices rely on the rotated credentials.

At step 716, the processor notifies the identified dependent remote computing devices to update their stored credentials based on the credential rotation, ensuring synchronized updates across the system.

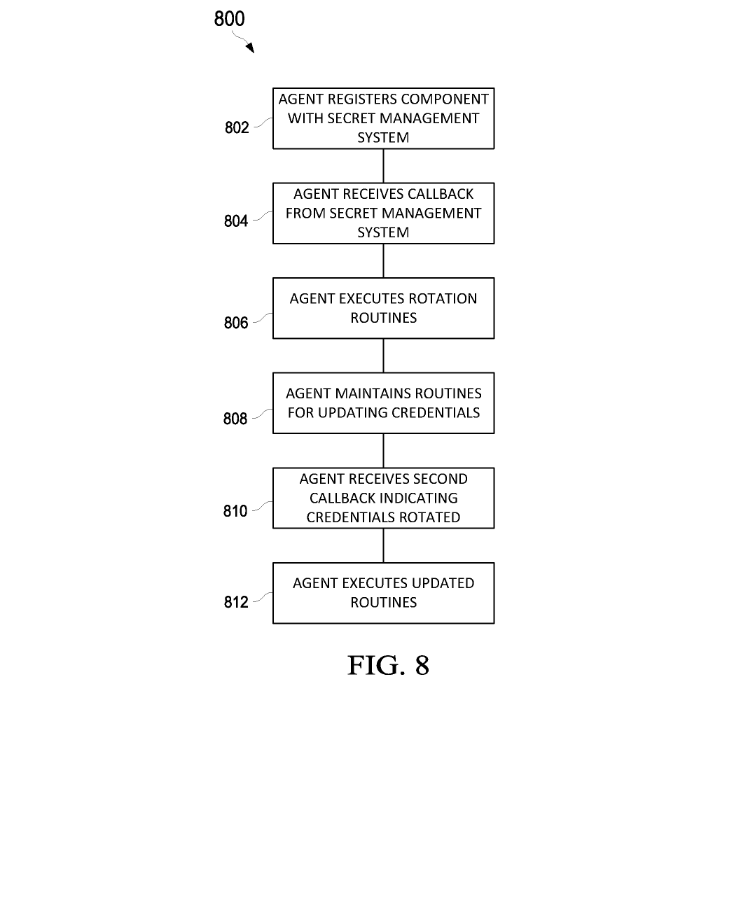

FIG. 8 illustrates a flowchart of an implementation method 800 for credential rotation. It is noted that all steps outlined in the method are not necessarily required and can be optional. Further, changes to the arrangement of the steps, removal of one or more steps and path connections, and addition of steps and path connections are similarly contemplated.

At step 802, an agent registers its component with a remote secret management system. During registration, the agent provides credential configurations for service accounts maintained by its component and dependency information specifying which service accounts from other components are mandatory for operation.

At step 804, the agent receives a first callback from the remote secret management system indicating that local credentials need rotation. This callback includes information to access newly generated credentials from the system's secure storage.

At step 806, the agent executes its rotation routines to implement the new credentials for its component while maintaining operational state. The agent may verify successful rotation and report status back to the management system.

At step 808, the agent maintains specific routines for updating credentials that its component uses to access other components. These routines incorporate knowledge of the component's implementation details and operational requirements.

At step 810, the agent receives a second callback from the remote secret management system indicating that credentials have been rotated for a component upon which its component depends.

At step 812, the agent executes its update routines to implement the new dependent credentials while maintaining operational access to the other component. This ensures continuous operation despite credential changes in dependent components.

While this method describes scheduled rotation operations, the system can also be configured to support immediate rotation triggered by security administrators. This capability enables the forced rotation of credentials for specific components or the entire system as part of security incident response procedures. Such administrator-triggered rotations follow the same steps but bypass the normal scheduling evaluation.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Where appropriate, any suitable operation or sequence described or illustrated herein may be interrupted, suspended, or otherwise controlled by another process, such as an operating system or kernel. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. Therefore, the appended claims are intended to encompass any such modifications or implementations.

What is claimed is:

1. A computer system for credential rotation, the computer system comprising:a secure storage device configured to store credentials;a non-transitory memory storage comprising instructions; anda processor in communication with the secure storage device and the non- transitory memory storage, wherein the processor executes the instructions to:receive registrations from remote computing devices, each registration comprising credential configurations and dependency information,maintain a dependency graph in the non-transitory memory storage based on the received registrations,store credential rotation policies in the non-transitory memory storage, detect a credential rotation trigger for a first remote computing device,generate new credentials according to the stored policies,store the new credentials in the secure storage device,notify the first remote computing device to perform credential rotation using the new credentials,identify dependent remote computing devices based on the dependency graph, andnotify the identified dependent remote computing devices to update their stored credentials based on the credential rotation.

2. The computer system of claim 1, wherein the credential configurations specify service accounts maintained by each remote computing device and service accounts from other remote computing devices that each remote computing device depends on.

3. The computer system of claim 1, wherein the processor executes the instructions to validate the received registrations against predefined schemas before maintaining the dependency graph.

4. The computer system of claim 1, wherein the credential rotation policies include a global default policy and component-specific policies, wherein the global default policy applies when component-specific policies are undefined.

5. The computer system of claim 1, wherein the processor executes the instructions to:verify successful credential rotation by the first remote computing device before notifying the identified dependent remote computing devices; andinitiate a rollback procedure if the credential rotation fails.

6. The computer system of claim 1, wherein the secure storage device maintains versions of previous credentials for each remote computing device to support rollback operations.

7. The computer system of claim 1, wherein the dependency graph represents service accounts as top-level vertices and remote computing devices as next-level vertices, with edges indicating which remote computing devices depend on which service accounts.

8. A non-transitory computer-readable media storing computer instructions for credential rotation, that when executed by a processor in communication with a secure storage device configured to store credentials, cause the processor to:receive registrations from remote computing devices, each registration comprising credential configurations and dependency information;maintain a dependency graph based on the received registrations;store credential rotation policies for the registered remote computing devices;
identify a first remote computing device requiring credential rotation on a scheduled rotation trigger;
generate new credentials according to the stored credential rotation policies;
store the new credentials in the secure storage device;
notify the first remote computing device to perform credential rotation using the new credentials;
identify dependent remote computing devices based on the dependency graph; and
notify the identified dependent remote computing devices to update their stored credentials based on the credential rotation.

9. The non-transitory computer-readable media of claim 8, wherein the instructions when executed by the processor, cause the processor to validate the received registrations against predefined schemas before storing the credential configurations.

10. The non-transitory computer-readable media of claim 8, wherein the credential rotation policies comprise:a global default policy defining default rotation requirements; andcomponent-specific policies that override the global default policy when defined for specific remote computing devices.

11. The non-transitory computer-readable media of claim 8, wherein the instructions when executed by the processor, cause the processor to:maintain configurable schedules for credential rotation across the registered remote computing devices; andevaluate each remote computing device's last rotation time against applicable policies during scheduled intervals.

12. The non-transitory computer-readable media of claim 8, wherein the instructions when executed by the processor, cause the processor to:verify successful credential rotation by the first remote computing device; and initiate rollback procedures using previously stored credentials if the credential rotation fails.

13. The non-transitory computer-readable media of claim 8, wherein the processor maintains encrypted versions of previous credentials in the secure storage device for each remote computing device.

14. The non-transitory computer-readable media of claim 8, wherein the dependency graph represents service accounts as top-level vertices and remote computing devices as next-level vertices, with edges indicating dependencies between service accounts and remote computing devices.

15. A computer-implemented method, comprising:registering with a remote secret management system by providing credential configurations and dependency information;receiving from the remote secret management system a first callback to rotate credentials;rotating local credentials based on the first callback;maintaining routines for updating dependent credentials;receiving from the remote secret management system a second callback indicating a rotation of credentials of a different computing device; andexecuting the routines to update the dependent credentials based on the second callback to maintain access to the different computing device.

16. The computer-implemented method of claim 15, wherein registering comprises:
providing service account configurations for service accounts maintained by a local computing device; and
declaring dependencies on service accounts from other computing devices mandatory for operation.

17. The computer-implemented method of claim 15, wherein rotating local credentials comprises:retrieving new credentials from a secure storage device of the remote secret management system;implementing the new credentials while maintaining operational access; andreporting rotation status back to the remote secret management system.

18. The computer-implemented method of claim 15, further comprising:verifying successful implementation of rotated credentials; andexecuting rollback procedures if credential rotation fails.

19. The computer-implemented method of claim 15, wherein the routines for updating dependent credentials are specific to a local computing device's implementation and are maintained by an agent that interfaces with the remote secret management system.

20. The computer-implemented method of claim 15, wherein executing the routines comprises:retrieving updated credentials for the different computing device from a secure storage device;implementing the updated credentials while maintaining operational access;
and verifying successful authentication using the updated credentials.
